(19) United States
(12) Patent Application Publication
(10) Pub. No.: US 2023/0259377 A1
(43) Pub. Date: Aug. 17, 2023

(54) USER INPUT PREDICTIVE ACTION SYSTEM AND METHOD FOR USER INTERFACES

(71) Applicant: Dell Products, L.P., Round Rock, TX (US)

(72) Inventors: Ming Qian, Allston, MA (US); Robert Alan Barrett, Austin, TX (US)

(73) Assignee: Dell Products, L.P., Round Rock, TX (US)

(21) Appl. No.: 17/650,743

(22) Filed: Feb. 11, 2022

(51) Int. Cl. G06F 9/455; G06F 3/04842

(52) U.S. Cl. CPC G06F 9/45512; G06F 3/04842

(57) ABSTRACT

Systems and methods provide a user input predictive action system and method for an Information Handling System (IHS). In some embodiments, the user input predictive action system includes computer-executable instructions to launch a Graphical User Interface (GUI) and a Command Line Interface (CLI) on a display, store usage information about a plurality of operations performed using at least one of the GUI or the CLI, and identify contextual information about one or more operations performed on the CLI or the GUI using the stored usage information. When the user is using the CLI, the instructions provide the contextual information to the user for aiding the user with entering a command using the CLI or the GUI.

### BACKGROUND

Information Handling Systems (IHSs) process, compile, store, and/or communicate information or data for business, personal, or other purposes. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Command line interfaces (CLIs), which may also be referred to as shell processors, are a common way to interact with a computer system. Commands may be entered as a sequence of typed characters (e.g., text and control characters) from a keyboard, and output may then be received as a string of text on a display. Such sequences typically take on the form of “do something”, “how”, and “to what”. In effect, the do something is a verb, how an adverb (e.g., should the command be executed “verbosely” or “quietly”), and the to what typically refers to one or more files on which the command should act. Included within these command sequences may be other characters such as inputs to the command, redirection characters to indicate where to route output, as well as other control characters. CLIs were some of the very first interactive interfaces in use. In spite of the advent of the graphical user interface (GUI), command-line shells remain critical administrative tools because the user commands can be easily batched to automatically perform multiple tasks without specific user interaction in batch mode. Despite being one of the first interactive interfaces, CLI is still preferred over GUI by “power users.” Modern operating systems (OSs) support different types of CLIs that allow users to interact with the system by entering commands from the keyboard and examining the text output, either directly or with the help of utilities built into the shell or which are designed to interact with it. They also allow the sequences of commands be executed on behalf of the user in the batch mode.

A GUI displays one or more windows with graphical controls, such as menus, list boxes, action buttons, and radio buttons. Many of the graphical controls are labeled. The graphical icons and labels communicate the current state of a computing device, and how they may be manipulated to change the state of the computing device. The GUI generates data indicating the properties to change and the new values for those properties. The GUI output is used to generate the instructions needed to effect the desired changes. Information to display within a GUI about a particular computing device may be generated from command lines supplied by the computing device to reflect its state. These command lines are parsed to extract information that is displayed in the GUI.

One advantage of the command line processor is that it may be run by any computer coupled to a network that is configured to run as a text-based or character terminal, such as workstations and personal computers that may run terminal emulators. A disadvantage of the command line interface is that it requires a user to know numerous commands, which may be cryptic, especially to a user whose use of the command line interface is intermittent. In addition, the command line interface is subject to other well-known limitations. Lines of commands and responses scroll rapidly off the screen.

CLIs have historically been character-oriented. This means that the shell command processor accepts character-by-character input from the user, waiting for a specific character (e.g., “Carriage return” or “Enter”) to signal that the shell should examine the input and try to execute it. When this character is supplied, the processor parses the input, determines if it is a legal command and begins executing it. Otherwise if it is not a legal command, the command executes and may generate character output of its own, which can be examined by the operator. The paradigm employed by the user is typically then to “open” the shell, supply characters to it via the keyboard and whenever the shell receives as input the Enter key, it attempts to process all characters it has received so far as a unit. Once the shell processor executes each unit as a command, it then reports the output. If an erroneous input was encountered, the processor may return a set of characters to the user which includes an error message. This cycle then repeats until the user “closes” the shell processor by terminating it.

### SUMMARY

Systems and methods provide a user input predictive action system and method for an Information Handling System (IHS). In some embodiments, the user input predictive action system includes computer-executable instructions to launch a Graphical User Interface (GUI) and a Command Line Interface (CLI) on a display, store usage information about multiple operations performed using at least one of the GUI or the CLI, and identify contextual information about one or more operations performed on the CLI or the GUI using the stored usage information. When the user is using the CLI, the instructions provide the contextual information to the user for aiding the user with entering a command using either the CLI or the GUI.

According to yet another embodiment, a user input predictive action method includes the steps of launching a Graphical User Interface (GUI) and a Command Line Interface (CLI) on a display, and storing the usage information about a multiple operations performed using at least one of the GUI or the CLI. The method may then perform the steps of identifying contextual information about one or more operations performed on the CLI or the GUI using the stored usage information, and providing the contextual information to the user for aiding the user with entering a command using either the CLI or the GUI.

According to another embodiment, a computer program product is configured with a computer readable storage medium having program instructions embodied thereon. The program instructions are executable by a processor to cause the processor to launch a Graphical User Interface (GUI) and a Command Line Interface (CLI) on a display in which the instructions are configured to store usage information about operations performed using at least one of the GUI or the CLI. The instructions may then identify contextual information about one or more operations performed on the CLI or the GUI using the stored usage information, and provide the contextual information to the user for aiding the user with entering a command using either the CLI or the GUI.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 illustrates an example user input predictive action system that may be used to assist users with interacting with a Command Line Interface (CLI) according to one embodiment of the present disclosure.

FIG. 2 is a block diagram illustrating components of an example Information Handling System (HIS) that may be used to implement certain features of the user input prediction action system according to one embodiment of the present disclosure.

FIG. 3 is a diagram showing how several details of the user input predictive action system may be used to generate recommendations for assisting a user entering commands from a CLI according to one embodiment of the present disclosure.

FIG. 4A illustrates an example contextual information deriving method that may be performed to collect usage information and generate contextual information according to one embodiment of the present disclosure.

FIG. 4B illustrates an example user input predictive action method that may be performed to aid a user with entering commands using a CLI according to one embodiment of the present disclosure.

FIG. 5 illustrates an example Graphical User Interface (GUI) that may be generated by the user input predictive action system according to one embodiment of the present disclosure.

FIGS. 6A through 6F illustrate an example CLI that may be generated by the user input predictive action system according to one embodiment of the present disclosure.

### DETAILED DESCRIPTION

Embodiments of the present disclosure provide a user input predictive action system and method that may be used to assist a user with entering commands using a Command Line Interface (CLI) launched from within a Graphical User Interface (GUI). Whereas CLI operation possesses certain benefits over GUIs, administrators have remained reluctant to rely solely on GUIs, particularly when these administrators are responsible for the management of large numbers of computing systems, such as those that may exist in a large computing environment. Embodiments of the present disclosure provide a solution to this problem, among others, using a technique that enables launching of a CLI from within a GUI in a manner that provides contextual information to be passed between the CLI and the GUI so that certain tasks provided by the CLI may be performed more easily.

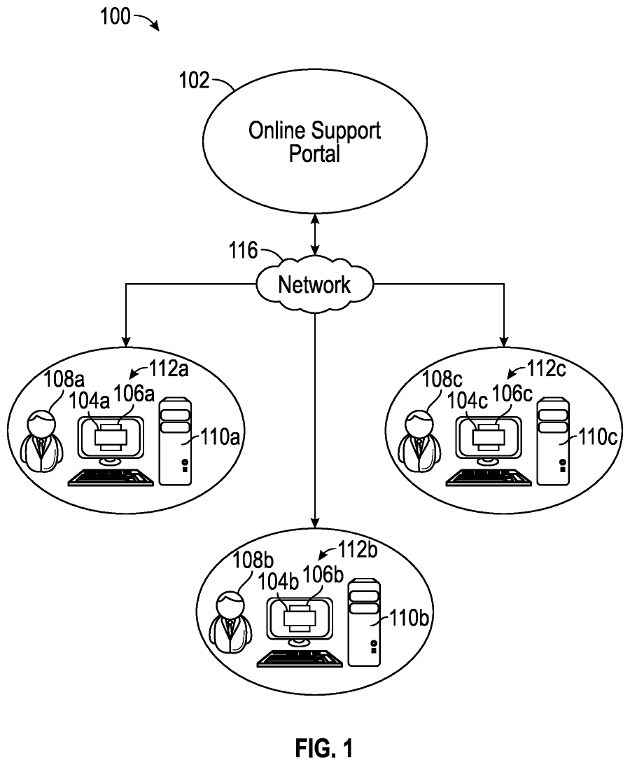

FIG. 1 illustrates an example user input predictive action system 100 that may be used to assist users with interacting with a CLI according to one embodiment of the present disclosure. The user input predictive action system 100 includes an online support portal 102 that communicates with, and continually obtains usage information associated with how a GUI 104a-c (collectively 104) and a corresponding CLI 106a-c (collectively 106) are being used by each of a number of users 108a-c (collectively 108). The GUI 104 and CLI 106 are displayed on a display 112a-c (collectively 112) of an Information Handling System (IHS) 110a-c (collectively 110). As shown, the online support portal 102 communicates with the IHSs 110 through a communication network 116, such as the Internet. Nevertheless, it should be appreciated that the GUI 104 and/or CLI 106 may communicate locally with the IHSs 110. The online support portal 102 may be any type that is administered by an organization, such as a corporation, school, or other enterprise that may supply IHSs 110 to some, most, or all of its members or customers. In one embodiment, the online support portal 102 may be, for example, one managed by a vendor of the IHSs 110.

Currently, Information Technology (IT) Administrators (a.k.a., Network Admins) typically do not trust GUI tools for monitoring and management as much as they trust CLI tools. One advantage of CLIs is that they may be executed by any computer that is configured to run as a text-based terminal, such as workstations and personal computers that execute terminal emulators. Another advantage of CLIs may be that the commands supported by CLIs are often more numerous than their GUI counterparts, and often include complex commands for performing certain tasks, such as configuring a computing device, or commands for retrieving information about the status of a particular computing device. Also, it would be beneficial to support CLI because power users prefer it, and because it empowers the user to perform automated tasks using scripts.

The inventors have discovered that it would be beneficial to provide a CLI that works in conjunction with a GUI to supply contextual content for enhancing a user's experience. Rather than trying to entirely replace CLIs with a GUI, it has been determined that improving both CLI and GUI experience may be accomplished by integrating the CLI with a GUI in a manner that allows actions performed by both the GUI and CLI to be analyzed for predicting and providing intelligent suggestions for their users. The usage information may be collected across different usage areas. For example, the system 100 may collect general console usage, peer console usage, Application Program Interface (API) usage, frequency of interactions with searches, components, objects and the like, CLI usage, alerts from multiple sources, health statuses from multiple sources, environmental changes (e.g., code changes), management system recommendations, ticketing system data, and organizational values just to name a few. This data will be collected into the contextual information generation engine 308 for processing and analysis to generate a data model that will provide insights and recommendations that will benefit both CLI and GUI user experiences. That is, the contextual information generation engine 308 may employ one or more pattern generation algorithms to analyze certain patterns and relationships between input sources, such as alerts, objects, actions, environment, context to generate recommendations for the users of both CLI and GUI interfaces.

As previously mentioned, certain types of users, such as IT Admins and software engineers rely on traditional CLIs to complete their day-to-day tasks. Research has shown that users often log into GUIs (e.g., a web-based systems management console) in order to reference information they need to use within the CLI. This is often a repetitive routine (e.g., Alt+Tab followed by copy/paste action) in which the users are continually using both the CLI and the GUI to accomplish their tasks. Additionally, the users commonly multi-task between multiple tools to accomplish their daily tasks. For example, they may start using a GUI, go to the GUI search function, get search results (e.g., IP address) and then copy and paste the search results into a CLI. But such actions are difficult to track given that actions of the CLI are not controlled relative to the GUI interface. Stated differently, there is often no explicit tracking of the data copy/paste exchange in addition to the fact that the system does not know what GUI data might inform CLI usage, or vice-versa. As such, the copy/paste GUI to CLI exchange of data is not being captured in any meaningful way. Thus, there is no data analysis in place, preventing any means of generating helpful CLI (or GUI) predictions/suggestions that could improve the user experience.

Nowadays, a relatively big pain point that users are experiencing is that they do not know what their peers are doing and what changes peers made within their shared environments that could impact the operations for which they are responsible. For example, Bob has a peer, Sally, that did a code update within a shared environment, which might impact Bob, thus enabling the tracking of the update. Even if the code update was communicated to Bob, for example through code-repository tool alerts, this information is not being captured nor analyzed for utilization and improvement in console usage tasks (e.g., monitoring, troubleshooting, etc.). Moreover, because of trust, experience and personal preference, many CLI users do not want to abandon using CLIs, which means they are spending less time within GUIs and therefore may be missing certain benefits that they may be unaware of.

Embodiments of the present disclosure provide a solution to these problems, among others, by continually monitoring and collecting CLI and GUI usage patterns performed by users, as well as usage information obtained from other inputs in order to analyze and generate patterns to provide informative suggestions in real-time during input. In some respects, the system 100 may be considered to be the backend that promotes a smart User Interface (UI) based on data collected from both the CLI and GUI. The analysis may not only improve the user experience for CLI, but it can also improve the GUI console experience, for example, by prioritizing information that appears in the GUI based on CLI usage.

The IHS 110 may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory.

Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components. An example of an IHS is described in more detail below.

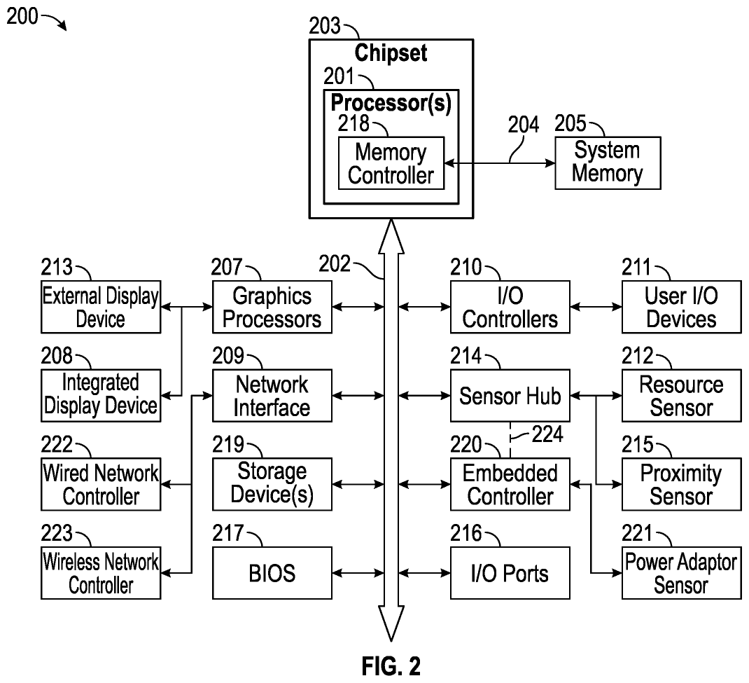

FIG. 2 is a block diagram illustrating components of an example IHS 200 that may be used to implement certain features of the user input prediction action system according to one embodiment of the present disclosure. For example, IHS 200 may be implemented in whole, or as a part of IHS 110, or online support portal 102. As shown, IHS 200 includes one or more processors 201, such as a Central Processing Unit (CPU), that execute code retrieved from system memory 205. Although IHS 200 is illustrated with a single processor 201, other embodiments may include two or more processors, that may each be configured identically, or to provide specialized processing operations. Processor 201 may include any processor capable of executing program instructions, such as an Intel Pentium™ series processor or any general-purpose or embedded processors implementing any of a variety of Instruction Set Architectures (ISAs), such as the x86, POWERPC®, ARM®, SPARC®, or MIPS® ISAs, or any other suitable ISA.

In the embodiment of FIG. 2, processor 201 includes an integrated memory controller 218 that may be implemented directly within the circuitry of processor 201, or memory controller 218 may be a separate integrated circuit that is located on the same die as processor 201. Memory controller 218 may be configured to manage the transfer of data to and from the system memory 205 of IHS 200 via high-speed memory interface 204. System memory 205 that is coupled to processor 201 provides processor 201 with a high-speed memory that may be used in the execution of computer program instructions by processor 201.

Accordingly, system memory 205 may include memory components, such as static RAM (SRAM), dynamic RAM (DRAM), and/or NAND Flash memory, suitable for supporting high-speed memory operations by the processor 201. In certain embodiments, system memory 205 may combine both persistent, non-volatile memory and volatile memory. In certain embodiments, system memory 205 may include multiple removable memory modules.

IHS 200 utilizes chipset 203 that may include one or more integrated circuits that are coupled to processor 201. In the embodiment of FIG. 2, processor 201 is depicted as a component of chipset 203. In other embodiments, all of chipset 203, or portions of chipset 203 may be implemented directly within the integrated circuitry of the processor 201. Chipset 203 provides processor(s) 201 with access to a variety of resources accessible via bus 202. In IHS 200, bus 202 is illustrated as a single element. Various embodiments may utilize any number of separate buses to provide the illustrated pathways served by bus 202.

In various embodiments, IHS 200 may include one or more I/O ports 216 that may support removable couplings with various types of external devices and systems, including removable couplings with peripheral devices that may be configured for operation by a particular user of IHS 200. For instance, I/O ports 216 may include USB (Universal Serial Bus) ports, by which a variety of external devices may be coupled to IHS 200. In addition to or instead of USB ports, I/O ports 216 may include various types of physical I/O ports that are accessible to a user via the enclosure of the IHS 200.

In certain embodiments, chipset 203 may additionally utilize one or more I/O controllers 210 that may each support the operation of hardware components such as user I/O devices 211 that may include peripheral components that are physically coupled to I/O port 216 and/or peripheral components that are wirelessly coupled to IHS 200 via network interface 209. In various implementations, I/O controller 210 may support the operation of one or more user I/O devices 211 such as a keyboard, mouse, touchpad, touchscreen, microphone, speakers, camera and other input and output devices that may be coupled to IHS 200. User I/O devices 211 may interface with an I/O controller 210 through wired or wireless couplings supported by IHS 200. In some cases, I/O controllers 210 may support configurable operation of supported peripheral devices, such as user I/O devices 211.

As illustrated, a variety of additional resources may be coupled to the processor(s) 201 of the IHS 200 through the chipset 203. For instance, chipset 203 may be coupled to network interface 209 that may support different types of network connectivity. IHS 200 may also include one or more Network Interface Controllers (NICs) 222 and 223, each of which may implement the hardware required for communicating via a specific networking technology, such as Wi-Fi, BLUETOOTH, Ethernet and mobile cellular networks (e.g., CDMA, TDMA, LTE). Network interface 209 may support network connections by wired network controllers 222 and wireless network controllers 223. Each network controller 222 and 223 may be coupled via various buses to chipset 203 to support different types of network connectivity, such as the network connectivity utilized by IHS 200.

Chipset 203 may also provide access to one or more display device(s) 208 and 213 via graphics processor 207. Graphics processor 207 may be included within a video card, graphics card or within an embedded controller installed within IHS 200. Additionally, or alternatively, graphics processor 207 may be integrated within processor 201, such as a component of a system-on-chip (SoC). Graphics processor 207 may generate display information and provide the generated information to one or more display device(s) 208 and 213, coupled to IHS 200.

One or more display devices 208 and 213 coupled to IHS 200 may utilize LCD, LED, OLED, or other display technologies. Each display device 208 and 213 may be capable of receiving touch inputs such as via a touch controller that may be an embedded component of the display device 208 and 213 or graphics processor 207, or it may be a separate component of IHS 200 accessed via bus 202. In some cases, power to graphics processor 207, integrated display device 208 and/or external display device 213 may be turned off, or configured to operate at minimal power levels, in response to IHS 200 entering a low-power state (e.g., standby).

As illustrated, IHS 200 may support an integrated display device 208, such as a display integrated into a laptop, tablet, 2-in-1 convertible device, or mobile device. IHS 200 may also support use of one or more external display devices 213, such as external monitors that may be coupled to IHS 200 via various types of couplings, such as by connecting a cable from the external display device 213 to external I/O port 216 of the IHS 200. In certain scenarios, the operation of integrated display devices 208 and external display devices 213 may be configured for a particular user. For instance, a particular user may prefer specific brightness settings that may vary the display brightness based on time of day and ambient lighting conditions.

Chipset 203 also provides processor 201 with access to one or more storage devices 219. In various embodiments, storage device 219 may be integral to IHS 200 or may be external to IHS 200. In certain embodiments, storage device 219 may be accessed via a storage controller that may be an integrated component of the storage device. Storage device 219 may be implemented using any memory technology allowing IHS 200 to store and retrieve data. For instance, storage device 219 may be a magnetic hard disk storage drive or a solid-state storage drive. In certain embodiments, storage device 219 may be a system of storage devices, such as a cloud system or enterprise data management system that is accessible via network interface 209.

As illustrated, IHS 200 also includes a Basic Input/Output System (BIOS) 217 that may be stored in a non-volatile memory accessible by chipset 203 via bus 202. Upon powering on or restarting IHS 200, processor(s) 201 may utilize BIOS 217 instructions to initialize and test hardware components coupled to the IHS 200. BIOS 217 instructions may also load an operating system (OS) (e.g., WINDOWS, MACOS, iOS, ANDROID, LINUX, etc.) for use by IHS 200.

BIOS 217 provides an abstraction layer that allows the operating system to interface with the hardware components of the IHS 200. The Unified Extensible Firmware Interface (UEFI) was designed as a successor to BIOS. As a result, many modern IHSs utilize UEFI in addition to or instead of a BIOS. As used herein, BIOS is intended to also encompass UEFI.

As illustrated, certain IHS 200 embodiments may utilize sensor hub 214 capable of sampling and/or collecting data from a variety of sensors. For instance, sensor hub 214 may utilize hardware resource sensor(s) 212, which may include electrical current or voltage sensors, that are capable of determining the power consumption of various components of IHS 200 (e.g., CPU 201, GPU 207, system memory 205, etc.). In certain embodiments, sensor hub 214 may also include capabilities for determining a location and movement of IHS 200 based on triangulation of network signal information and/or based on information accessible via the OS or a location subsystem, such as a GPS module.

In some embodiments, sensor hub 214 may support proximity sensor(s) 215, including optical, infrared, and/or sonar sensors, which may be configured to provide an indication of a user's presence near IHS 200, absence from IHS 200, and/or distance from IHS 200 (e.g., near-field, mid-field, or far-field).

In certain embodiments, sensor hub 214 may be an independent microcontroller or other logic unit that is coupled to the motherboard of IHS 200. Sensor hub 214 may be a component of an integrated system-on-chip incorporated into processor 201, and it may communicate with chipset 203 via a bus connection such as an Inter-Integrated Circuit (I2C) bus or other suitable type of bus connection. Sensor hub 214 may also utilize an I2C bus for communicating with various sensors supported by IHS 200.

As illustrated, IHS 200 may utilize embedded controller (EC) 220, which may be a motherboard component of IHS 200 and may include one or more logic units. In certain embodiments, EC 220 may operate from a separate power plane from the main processors 201 and thus the OS operations of IHS 200. Firmware instructions utilized by EC 220 may be used to operate a secure execution system that may include operations for providing various core functions of IHS 200, such as power management, management of operating modes in which IHS 200 may be physically configured and support for certain integrated I/O functions.

EC 220 may also implement operations for interfacing with power adapter sensor 221 in managing power for IHS 200. These operations may be utilized to determine the power status of IHS 200, such as whether IHS 200 is operating from battery power or is plugged into an AC power source (e.g., whether the IHS is operating in AC-only mode, DC-only mode, or AC+DC mode). In some embodiments, EC 220 and sensor hub 214 may communicate via an out-of-band signaling pathway or bus 224.

In various embodiments, IHS 200 may not include each of the components shown in FIG. 2. Additionally, or alternatively, IHS 200 may include various additional components in addition to those that are shown in FIG. 2. Furthermore, some components that are represented as separate components in FIG. 2 may in certain embodiments instead be integrated with other components. For example, in certain embodiments, all or a portion of the functionality provided by the illustrated components may instead be provided by components integrated into the one or more processor(s) 201 as an SoC.

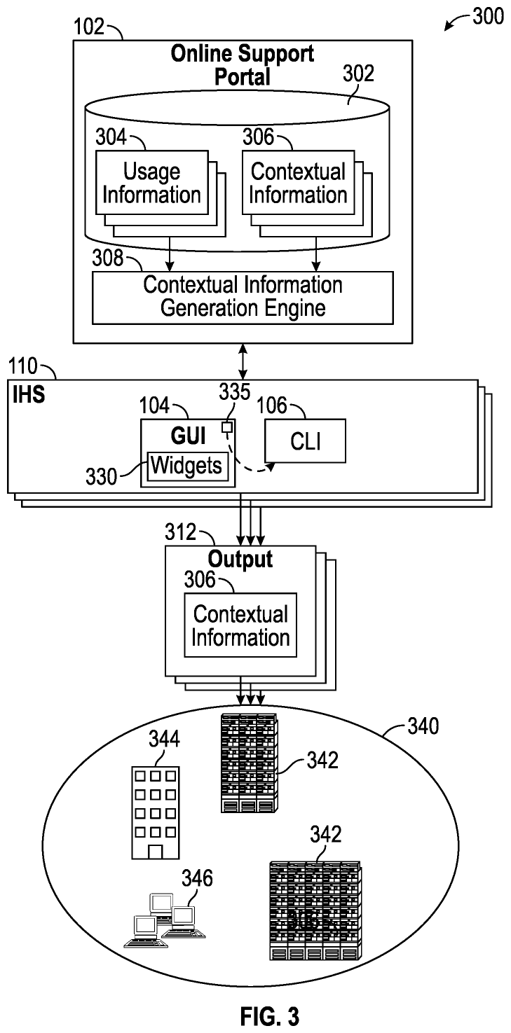

FIG. 3 is a diagram showing how several details of a user input predictive action system 300 showing how the online support portal 102 may be used to generate recommendations for assisting a user entering commands from a CLI according to one embodiment of the present disclosure. The user input predictive action system 300 generally includes a computing environment 340 that is managed by one or more GUIs 104 and CLIs 106 configured on each of a number of IHSs 110. For example, the GUIs 104 and CLIs 106 may form at least a portion of a systems management appliance such as the Dell EMC OpenManage Enterprise (OME) systems manager that is installed on a secure virtual machine (VM), such as a VMWARE Workstation.

The online support portal 102 generally includes a historical usage database 302 for storage of usage information 304 from which contextual information 306 may be analyzed using a contextual information generation engine 308, which may include, for example, a Machine Learning (ML) engine. As the contextual information generation engine 308 generates recommendations, they may be used to assist a user 108 with applying certain commands from a CLI 106 based upon recent activity identified in the user's usage patterns. The contextual information 306 may also include user account and/or profile information.

In general, the contextual information generation engine 308 collects data, via the usage information 304 to generate contextual information 306 that may be included in the output 312 of the CLI 106 and/or GUI 104. For example, when a user 108 inputs certain alpha-numeric text into the CLI 106, the system may derive contextual information 306 about one or more operations performed on the CLI using the stored usage information 304, and provide the contextual information 306 to the user for aiding the user with entering a command using the CLI 106. That is, the contextual information 306 may be included as part of a command used to manage one or more IHSs configured in the computing environment 340.

In one embodiment, the CLI 106 may be launched using a CLI selection mechanism 335 configured on the GUI 104. The CLI selection mechanism 335 may be, for example, a selectable button configured on the display window of the GUI 104. Such a feature may be useful for coupling the actions performed on the GUI 104 with those performed by the CLI 106. For example, when the CLI 106 is launched via the GUI 104, both the GUI 104 and CLI 106 may be executed via a single thread or process so that contextual information 306 may be derived via the use of both GUI 104 and CLI 106.

The user input predictive action system 300 captures usage data across multiple platforms including the GUI 104 as well as the CLI 106 that is accessed via the GUI 104, and stores that usage data in a historical usage database 302. While the present embodiment describes the CLI 106 being accessed via the GUI 104, it is contemplated that the CLI 106 may be accessed independently of GUI 104 in other embodiments. The data that the user input predictive action system 300 collects may include general console usage, peer console usage, API usage, frequency of interactions with certain searches, components, and/or objects, CLI usage, alerts from multiple sources, health status reports from multiple sources, environmental changes (e.g., code changes), systems manager (e.g., APEX) recommendations, ticketing system data, and organizational values. Some, most, or all of this data may be collected for processing and analysis to generate a data model that will provide insights and recommendations that will benefit both CLI and GUI user experiences. The suggested pattern generation algorithms used by the contextual information generation engine 308 may analyze the patterns and relationships between alerts, objects, actions, environment, context to assist users of the CLI 106 and/or GUI 104. In one embodiment, the contextual information 306 is generated using widgets 330 that are loaded into the IHS 110 during runtime to impart the recommendations into the CLI 106, for example, as the user 108 is typing.

In one embodiment, the contextual information generation engine 308 generates the contextual information using a Machine Learning (ML) engine. In general, the ML engine obtains characteristics of the IHSs 110 along with the characteristics of usage information 304 obtained from the habits of users 108 to characterize the how the computing environment 340 is being used. Once the ML engine has collected a sufficient amount of data, it may then process the collected data using statistical descriptors to extract the contextual-based features of the CLI 106 and/or GUI 104. The ML engine may use any suitable machine learning algorithm such as, for example, a Bayesian algorithm, a Linear Regression algorithm, a Decision Tree algorithm, a Random Forest algorithm, a Neural Network algorithm, or the like. The ML engine may then evaluate the features to generate a trained ML model to derive one or more elements of contextual information 306.

The contextual information generation engine 308 uses the contextual information 306 to aid the user 108 in generating commands via the CLI 106. For example, the contextual information generation engine 308 may be executed on an IHS configured in the online support portal 102, which communicates with the IHSs in the computing environment 340 through a network, such as the Internet. The contextual information generation engine 308 may obtain the usage information in any suitable manner. In one embodiment, the engine 308 may obtain the usage information from a baseboard management controller (BMC) (e.g., remote access controller or chassis management controller). The BMC allows information technology (IT) administrators to deploy, update, monitor, and maintain the IHS 110 remotely. As a non-limiting example of a remote access controller, the integrated Dell Remote Access Controller (iDRAC) from Dell® is embedded within Dell PowerEdge™ servers and provides such remote functionality. The contextual information generation engine 308 may communicate with the baseboard management controller to obtain the usage information.

In general, the GUI 104 and/or CLI 106 is configured to monitor and control any number of IHSs (e.g., computing devices) in the computing environment 340. The computing environment 340 may include any type and quantity of computing devices, such as those that may be included in a computing cluster 342, one or more data centers 344, or multiple computing devices 346 of an organizational entity, such as a business, or school. In one embodiment, certain computing devices of the computing clusters 342 and/or data center 344 may be similar in design and construction to the IHS 200 as described above with reference to FIG. 2.

In a particular example, the computing environment 340 may be one managed by a single entity, such as a vendor of the computing devices, or some other large organization having a first computing cluster 342 located in a first location, a second computing cluster 342 located in a second location, a data center 344 located in a third location, and multiple computing devices 346 located in a fourth location. Thus, the number and type of computing devices managed by the GUI 104 and/or CLI 106 can, and often does, vary widely across the computing environment that it is designed to manage.

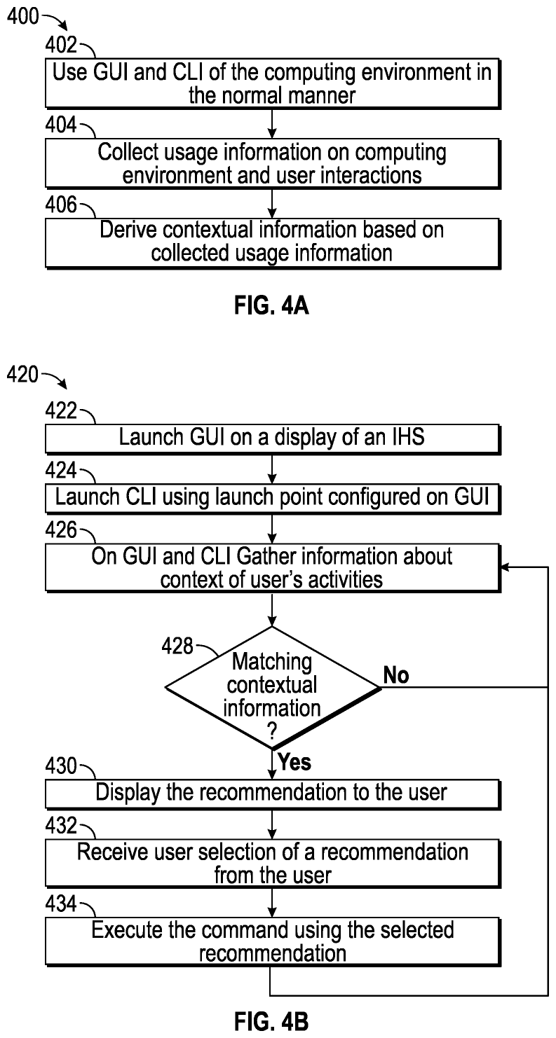

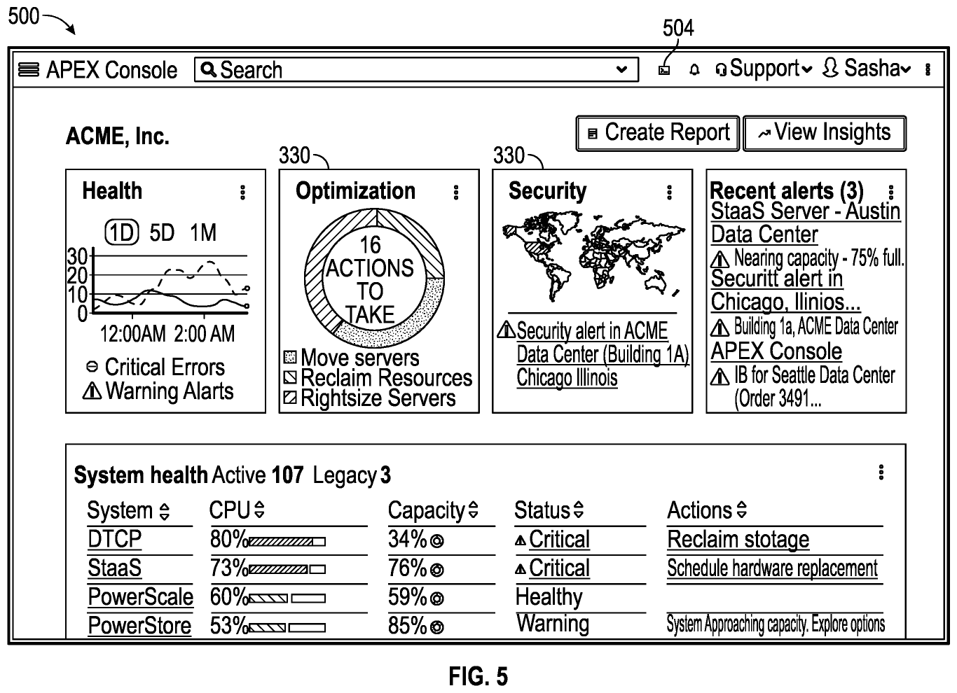

FIG. 4A illustrates an example contextual information deriving method 400 that may be performed to collect usage information and generate contextual information according to one embodiment of the present disclosure. In some embodiments, at least a portion of the steps of the method 400 may be performed by the system 100 of FIG. 1. While the method 400 only describes collecting data from one GUI 104 and CLI 106 during one session, it should be appreciated that the method 400 may be used to collect and analyze usage information from multiple users 108 who each may perform certain activities over a number of login sessions over an extended period of time. For example, the users 108 may be members of a certain group of people (IT Administrators) who are responsible for maintaining a data center, or a group of data centers dispersed over a geographic region such as described above with reference to FIG. 3.

At step 402, the CLI and GUI of computing environment 340 is used in a normal manner. During its normal use, the method 400 collects usage information on the computing environment 340 and user interactions via the GUI 104 and/or CLI 106 at step 404. The method 400 may collect usage information 304 from each of the GUIs 104 and CLIs 106 used to manage the computing environment 340. For example, the contextual information generation engine 308 may collect some, most, or all activities performed by certain users 108, such as a few days to a few weeks, until sufficient data may be obtained from which one or more elements of contextual information 306 may be derived. The activities may include, for example, a certain command or group of commands that are entered to configure an IHS 110 in the computing environment 340, a certain software upgrade that is performed on the IHS 110. Other usage information may include general console usage, peer console usage, API usage, frequency of interactions with searches, components, objects and the like. The method 400 may also collect event information, such as any alarm or alert signals indicating the existence of problems with an IHS 110, processing, networking, and/or storage capacity crossing certain threshold levels, and the like.

Thereafter at step 406, the method 400 derives contextual information 306 based on the collected usage information 304. For example, the contextual information generation engine 308 may predict a pattern of usage that occurs following the detection of an event, or a certain sequence of commands that are repeatedly performed by the users 108. As another example, the method 400 may detect that other users have already performed a software upgrade on a particular video card. Thus, the method 400 may identify other IHS's whose video cards have not yet been upgraded so that, when a user begins working on one of the IHSs with the non-upgraded video card, a notification message indicating the availability of the software upgrade may be sent to the user. As yet another example, the method 400 may, upon detecting that the user is diagnosing a failure, present past solutions that have been used to fix the failure.

The method 400 may be continually performed for each piece of usage information that is obtained. Nevertheless, when use of the contextual information deriving method 400 is no longer needed or desired, the method 400 ends.

FIG. 4B illustrates an example user input predictive action method 420 that may be performed to aid a user with entering commands using a CLI according to one embodiment of the present disclosure. In some embodiments, at least a portion of the steps of the method 400 may be performed by the system 100 of FIG. 1. While the method 420 described herein focuses on assistance that may be provided to a user via a CLI 106, it is contemplated that in other embodiments, certain steps of the disclosed process may also be used to provide assistance to the user via a GUI 104. The method 420 may be performed at any suitable time. In one embodiment, the method 420 may be performed after method 400 is performed for a sufficient amount of time (e.g., a few hours to a few weeks) so that contextual information can be generated.

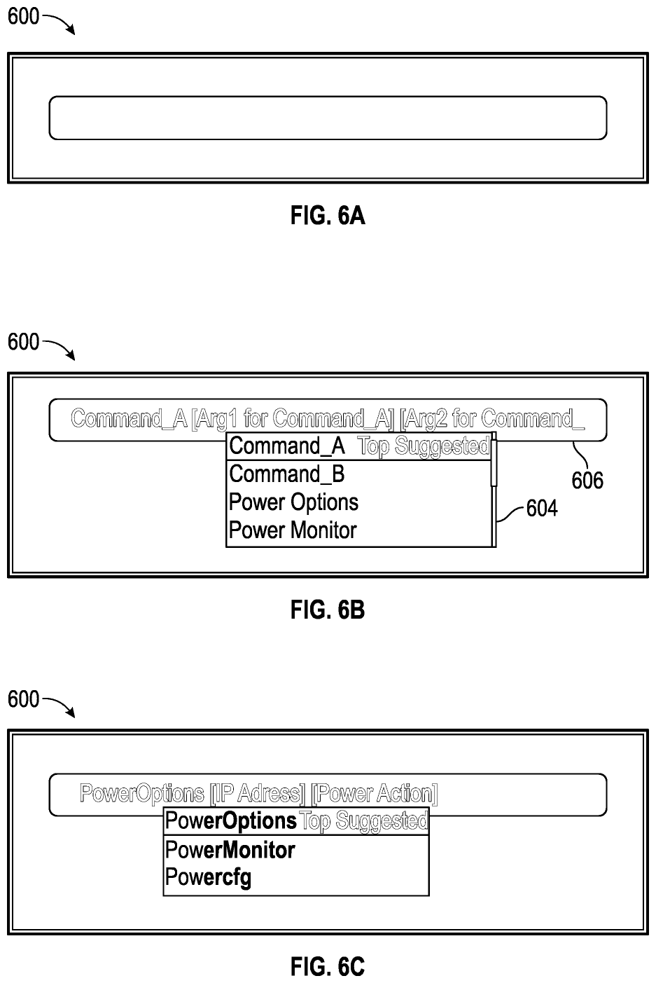

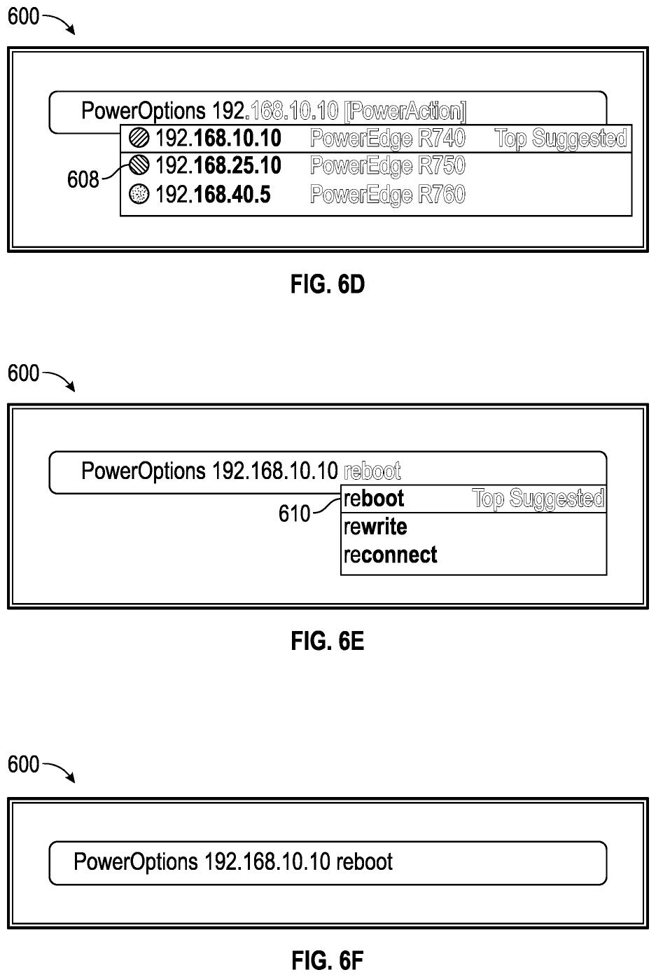

At step 422, the method 400 launches a GUI 104 on a display of an IHS 110. In one embodiment, the GUI 104 may be launched as a result of successfully entering a login session by a user 108. At step 424, the method 400 launches a CLI 106 using a launch point configured on the GUI 104. For example, FIG. 5 illustrates an example GUI 500 that presents a systems manager user interface to the user 108 in which the GUI 500 includes a selectable button 504 that when selected by the user 108, causes a CLI 600 to be generated on the display, such as shown in FIGS. 6A-6F. For example, the GUIs 104 and CLIs 106 may form at least a portion of a systems management appliance such as the Dell EMC OpenManage Enterprise (OME) systems manager provided by DELL TECHNOLOGIES. Additional features of the operation of the GUI 500 and its associated CLI 600 will be described in detail herein below.

Activities of the GUI 104 may be used to influence contextual information 306 that is provided to the CU 106. Additionally, activities of the CU 106 may be used to influence contextual information 306 that is provided to the GUI 104. For example, the system may generate certain widgets 330 that are displayed on the GUI 104 based upon activities detected on the CU 106. In a particular example, when the system detects certain security-based activities performed on the CU 106, it may generate a security-based widget 330 on the GUI 104. Conversely, when the system detects certain optimization-based activities occurring on the GUI 104, it may provide certain optimization-based features to the user via the CU 106.

At step 426, the method 420 gathers information about a context of user's activities via the GUI 104 and/or CLI 106. The method 420 may gather context information from use of the GUI 104 or by receiving user input (e.g., entry of alpha-numeric text) from the user via the CLI 106. The method 420 then determines whether any derived element of contextual information matches the entered text at step 428. If not, processing continues as step 426 to receive additional text information through the CLI 106. If however, a match is found, processing continues at step 430.

Thereafter at step 430, the method 420 displays the contextual information for view by the user, and receives user selection of a recommendation from the user at step 432. For example, after launching the CLI 106 as shown in FIG. 6A, the method 420 determines that the user has been diagnosing a power supply problem, and as such, generates a first pop-up menu window 604 at FIG. 6B displaying certain CLI-based commands that may be useful in resolving the power supply problem. For example, the method 420 may use the widget 330 as described above with reference to FIG. 3 to generate the pop-up menu window 604 and receive selection of one element from the user. Moreover, when the user focuses on one particular command (e.g., by moving a mouse pointer over a particular command), the method 420 may then highlight the command in the entry field of the CLI 600 along with arguments 606 to that command as shown in FIG. 6C. As best shown in FIG. 6D, after the user selects a particular command “PowerOptions,” the method 420 may also display a second pop-up menu window 608 that displays an IP address of certain IHSs that the method 420 has determined to be experiencing the same problem. When a particular IP address has been selected, the method 420 may then display a third pop-up menu window 610 of valid arguments that may be applied to the command as shown in FIG. 6E. FIG. 6F shows the command which is ready to be entered for manipulating the operation of the IHS associated with the selected IP address.

At step 434, the command is executed by the method 420. The method 420 described above may be continually performed as the user is entering text into the CLI 600. Nevertheless, when use of the method 420 is no longer needed or desired, the process ends.

Although FIGS. 4A and 4B each describe example methods 400 and 420 that may be performed to aid the user in selection of text to be included in a CLI, the features of the methods 400 and 420 may be embodied in other specific forms without deviating from the spirit and scope of the present disclosure. For example, either of the methods 400 or 420 may perform additional, fewer, or different operations than those described in the present examples. As another example, certain steps of either of the aforedescribed methods 400 or 420 may be performed in a sequence different from that described above. As yet another example, certain steps of either of the methods 400 and 420 may be performed by other components in the IHS 102 other than those described above.

It should be understood that various operations described herein may be implemented in software executed by logic or processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. A user input predictive action system comprising:
at least one processor;
at least one memory coupled to the processor, the memory having instructions stored thereon that, upon execution by the at least one processor, cause the system to:
launch a Graphical User Interface (GUI) and a Command Line Interface (CLI) on a display;
store usage information about a plurality of operations performed using at least one of the GUI or the CLI;
identify contextual information about one or more operations performed on the CLI using the stored usage information; and
provide the contextual information to the user for aiding the user with entering a command using the CLI or the GUI, wherein the command and all of the arguments associated with the command comprise a plurality of characters contiguously aligned on a single entry field.

2. The user input predictive action system of claim 1, wherein the instructions, upon execution, further cause the system to upon user selection of a launch point of the GUI generate the CLI on the display.

3. The user input predictive action system of claim 1, wherein the instructions, upon execution, further cause the system to generate the contextual information using a Machine Learning (ML) process.

4. The user input predictive action system of claim 1, wherein operations are performed by a plurality of users.

5. The user input predictive action system of claim 1, wherein the instructions, upon execution, further cause the system to manage operations of a computing environment.

6. The user input predictive action system of claim 1, wherein the instructions, upon execution, further cause the system to identify the contextual information about operations performed on the CLI using a cloud-based portal.

7. The user input predictive action system of claim 1, wherein the instructions, upon execution, further cause the system to identify the contextual information about the one or more operations performed on the CLI using usage information comprising at least one of console usage, peer console usage, Application Program Interface (API) usage, frequency of interactions with searches, frequency of interactions with components, frequency of interactions with objects, CLI usage, alert messages, health status messages, environmental changes, management system recommendations, ticketing system data, or organizational values.

8. The user input predictive action system of claim 1, wherein the instructions, upon execution, further cause the system to access the CLI using a thread used by the GUI.

9. The user input predictive action system of claim 1, wherein the instructions, upon execution, further cause the system to provide the contextual information to the user for aiding the user with performing an operation using the GUI.

10. A user input predictive action method comprising:
launching a Graphical User Interface (GUI) and a Command Line Interface (CLI) on a display;
storing usage information about a plurality of operations performed using at least one of the GUI or the CLI;
identifying contextual information about one or more operations performed on the CLI using the stored usage information; and
providing the contextual information to the user for aiding the user with entering a command using the CLI or the GUI, wherein the command and all of the arguments associated with the command comprise a plurality of characters contiguously aligned on a single entry field.

11. The user input predictive action method of claim 10, further comprising generating the CLI on the display upon user selection of a launch point of the GUI.

12. The user input predictive action method of claim 10, further comprising generating the contextual information using a Machine Learning (ML) process.

13. The user input predictive action method of claim 10, wherein operations are performed by a plurality of users.

14. The user input predictive action method of claim 10, further comprising identifying the contextual information about the one or more operations performed on the CLI using a cloud-based portal.

15. The user input predictive action method of claim 10, further comprising accessing the CLI using a thread that is used by the GUI.

16. The user input predictive action method of claim 10, further comprising providing the contextual information to the user for aiding the user with performing an operation using the GUI.

17. A computer program product comprising a non-transitory computer-readable memory device having program instructions embodied therewith that, upon execution by a processor to cause the processor to perform the following:
launch a Graphical User Interface (GUI) and a Command Line Interface (CLI) on a display, the instructions configured to store usage information about operations performed using at least one of the GUI or the CLI;
identify contextual information about one or more operations performed on the CLI using the stored usage information; and
provide the contextual information to the user for aiding the user with entering a command using the CLI or the GUI, wherein the command and all of the arguments associated with the command comprise a plurality of characters contiguously aligned on a single entry field.

18. The computer program product of claim 17, wherein the instructions, upon execution, further cause the processor to, upon user selection of a launch point of the GUI, generate the CLI on the display.

19. The computer program product of claim 17, wherein the instructions, upon execution, further cause the processor to generate the contextual information using a Machine Learning (ML) process.

20. The computer program product of claim 17, wherein operations are performed by a plurality of users.
